(19) United States
(12) Patent Application Publication
(10) Pub. No.: US 2014/0363803 A1
(43) Pub. Date: Dec. 11, 2014

(54) Method and System for Correlating Participants to Learning

(71) Applicant: George TATTERSFIELD, San Jose, CA (US)

(72) Inventor: George TATTERSFIELD, San Jose, CA (US)

(21) Appl. No.: 14/299,882

(22) Filed: Jun. 9, 2014

Related U.S. Application Data
(60) Provisional application No. 61/832,525, filed on Jun. 7, 2013.

(51) Int. Cl. G09B 7/04

(52) U.S. Cl. CPC G09B 7/04
USPC 434/353; 434/322

(57) ABSTRACT

A method is disclosed for remediating education. A population of students past and present and a plurality of teachers are provided. Also provided is a curriculum having sub-elements therein. A plurality of questions each relating to a specific sub-element within the curriculum is formed. A dataset including a plurality of answers to each of the plurality of questions is provided for processing thereof, the answers each relating to a student from the population of students and to a teacher of the plurality of teachers who taught the student material relating to the sub-element. The answers of current students within a grade level are correlated against the answers of former students at that grade level to form correlated student groups. Based on answers provided in subsequent years by students within a same. correlated student group and the teachers associated with those answers, assigning students within the correlated student group to teachers from a first plurality of teachers for a subsequent lesson comprising material for teaching the same sub-element.

### CROSS-REFERENCE TO RELATED APPLICATIONS

This application claims the benefit of U.S. Provisional Patent Application No. 61/832,525, Jun. 7, 2013, and incorporates the disclosure of the application by reference.

### FIELD OF THE INVENTION

The invention relates to education and more particularly to verification and remediation of education.

### BACKGROUND

Teaching has existed for thousands of years. In the classical teaching paradigm, it is not the teacher's responsibility to teach so much as it is the student's responsibility to learn. Traditionally, teachers were selected based on their knowledge and reputation and students worked hard to earn the time of those reputed “wise men.”

More recently, schools have been organized to teach larger numbers of students in a comparable fashion. As many will attest, schools aim to teach the students in a common standard to achieve a common result. That said, many students fail to flourish. Over the past decades, psychologists have defined a series of tests to try to highlight learning styles of students in order to suggest methods and mechanisms for improved teaching of specific types of students. Though schools have started to adopt these tests and the results of the tests, there exists a significant problem in addressing learning styles and issues within the present school system.

In the present environment, blame for poor education is being passed around between government for lack of funding, unions that prevent bad teachers from being fired, teachers for failing to teach, students for not doing the work, parents for having insufficient time to support theft children, curricula for including too much material, etc. The blame game is one in which all parties try to avoid being blamed instead of co-operating to achieve the necessary goals. Clearly, a different solution is needed.

It would be advantageous to provide a method and system for overcoming drawbacks of prior art education systems.

### SUMMARY OF THE INVENTION

In accordance with an embodiment of the invention there is provided a method comprising: providing a population of students past and present; providing a plurality of teachers; providing a curriculum having sub-elements therein; providing a plurality of questions each relating to a specific sub-element within the curriculum; providing a plurality of answers to each of the plurality of questions, the answers each relating to a student. from the population of students and to a teacher of the plurality of teachers who taught the student material relating to the sub-element; correlating the answers of current students within a grade level against the answers of former students at that grade level to form correlated student groups; providing a first plurality of teachers for teaching material for teaching a same sub-element; and based on answers provided in subsequent years by students within a same correlated student group and the teachers associated with those answers, assigning students within the correlated student group to teachers from the first plurality of teachers for a subsequent lesson comprising material for teaching the same sub-element.

In accordance with an embodiment of the invention there is also provided a method comprising: providing a population of students; providing a plurality of questions each relating to a specific sub-element within a curriculum; receiving an answer to each of the plurality of questions from each member of the population of students; for each sub-element determining one of competence and lack of competence for each student within the population of students based on the answers provided; and providing at an output port a visual indication of specific remediation based on the determination.

In accordance with an embodiment of the invention there is also provided a method comprising: providing a plurality of questions each relating to a specific sub-element within a curriculum; providing a plurality of students having learned the specific sub-element from a same teacher; receiving an answer to each of the plurality of questions, from each student within the plurality of students; for each sub-element determining one of competence and lack of competence of the teacher based on the answers provided; and suggesting specific remediation for the teacher based on the determination.

In accordance with an embodiment of the invention there is also provided a method comprising: providing a student; providing a standard curriculum having sub-elements therein; providing a plurality of questions each relating to a specific sub-element within the curriculum, the plurality of questions provided in electronic form and stored within a common data store; providing to the student a portion less than the whole of the plurality of questions, the portion selected form the plurality of questions; providing from the student a plurality of answers to the provided questions; automatically correlating the plurality of answers against sub-elements of the standard curriculum to determine portions of the standard curriculum that are satisfactorily understood and portions that require remediation.

In accordance with an embodiment of the invention there is provided a system comprising: a processor and data store for providing a population of students past and present; providing a plurality of teachers; providing a curriculum having sub-elements therein; providing a plurality of questions each relating to a specific sub-element within the curriculum; providing a plurality of answers to each of the plurality of questions, the answers each relating to a student from the population of students and to a teacher of the plurality of teachers who taught the student material relating to the sub-element; correlating the answers of current students within a grade level against the answers of former students at that grade level to form correlated student groups; providing a first plurality of teachers for teaching material for teaching a same sub-element; and based on answers provided in subsequent years by students within a same correlated student group and the teachers associated with those answers, assigning students within the correlated student group to teachers from the first plurality of teachers for a subsequent lesson comprising material for teaching the same sub-element.

### BRIEF DESCRIPTION OF THE DRAWINGS

Embodiments of the invention will now be described with reference to the drawings in which like numbered elements are similar and in which:

FIG. 1, is simplified flow diagram of a prior art method of grading.

FIG. 2 is a simplified block diagram of a standard comprising standard elements for being taught.

FIG. 3 is a simplified flow diagram of a method of matching a standard against an educational result.

FIG. 4 is a simplified diagram of a teacher requiring improvement in his teaching style and a student in need of relearning a topic.

FIG. 5 is a simplified block diagram of a standard element, sub-elements and questions for the sub-elements.

FIG. 6 is a simplified block diagram of a method of using test results to select a teacher.

FIG. 7 is a simplified flow diagram of a method of evaluating a student upon system entry to determine remediation.

FIG. 8 is a simplified flow diagram of a method of notifying a teacher of potential issues.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

### Definitions

Standard is a set of criteria for defining requirements of an education process, be it an education for a school, for a course, or for a topic.

Standard element is a single criterion within a standard for defining requirements.

Standard sub-element is a single criterion within a standard element for defining requirement components thereof.

The school system in the United States is being widely criticized. One known problem with the school system is its emphasis on grades. In a grade-oriented system, tests measure each student's performance and allow the students to be ranked. Ranks are used to try to specify an individual student's capabilities. The present grading system leaves the responsibility for education on the student—a logical place to rest responsibility in view of the student having the greatest control over their performance. That said, there are other players in the educational process.

To this end, standardized tests have been implemented to evaluate and rate schools and the teachers within those schools. In some districts, the tests have been used to determine pay/bonuses. in others, they are used to rank schools and help consumers know which schools to avoid. Thus, schools and teachers can he graded like students.

It has now been found that what is needed is a specific set of verifications to evaluate performance of more players in the educational process and to actively remediate the educational process to improve results.

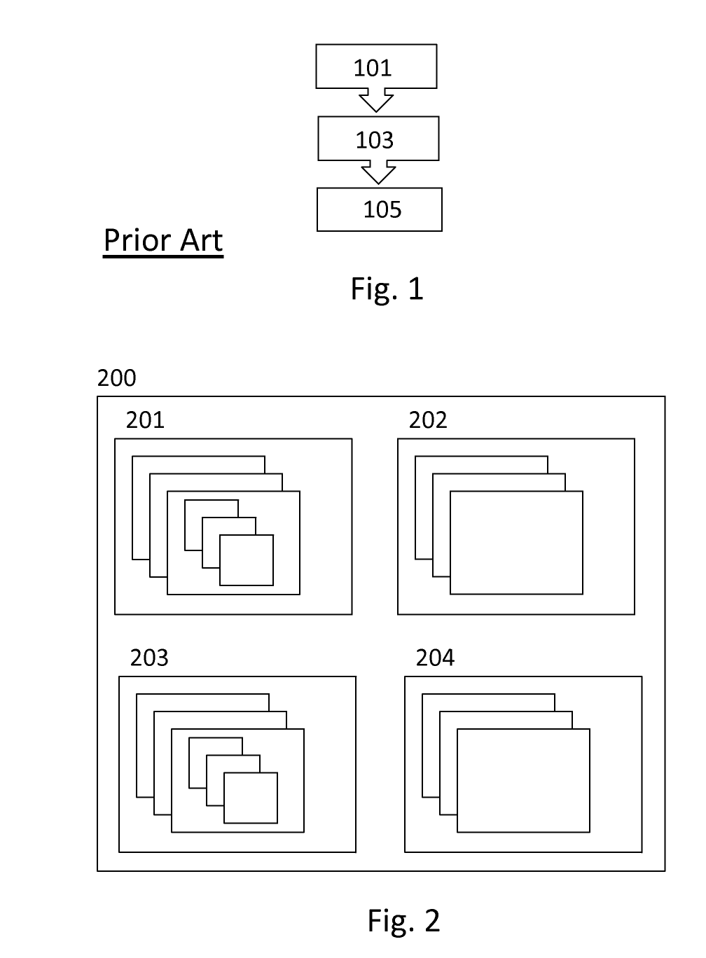

Referring to prior art FIG. 1, shown is a simplified flow diagram of a method of grading. At 101, each student is provided with an identical test to ensure that results are comparable across the population. The students answer the questions on the test and submit the test answers for grading at 103. A grade is determined based on a correctness of the answers and the grade is assigned to the student resulting in a relative ranking of students at 105.

Referring to FIG. 2, shown is a simplified block diagram of a standard comprising standard elements—shown as boxes—for being taught. The standard 200 is an attempt to codify the education process such that each student is taught similar material system wide. Standards exist in many jurisdictions and a national standard would hold every school in the nation accountable to a common teaching expectation. Here, each standard element, boxes 201, 202, 203 and 204, are shown to comprise a plurality of constituent boxes, sub-elements, that are included within each of the standard element elements 201, 202, 203 and 204. Thus, a hierarchy of standard elements is formed. In some embodiments, the standard, includes several layers of sub-elements—sub-sub elements, etc. such as in standard elements 201 and 203. in those embodiments, the several layers are optionally flattened to form a greater number of sub-elements. Effectively, though shown as a hierarchy representing a standard, it is understood that this is for convenience and for human readability and that flattening the entire standard to standard elements would effectively retain the same information so long as the sub-elements form a complete representation of the standard elements they are within.

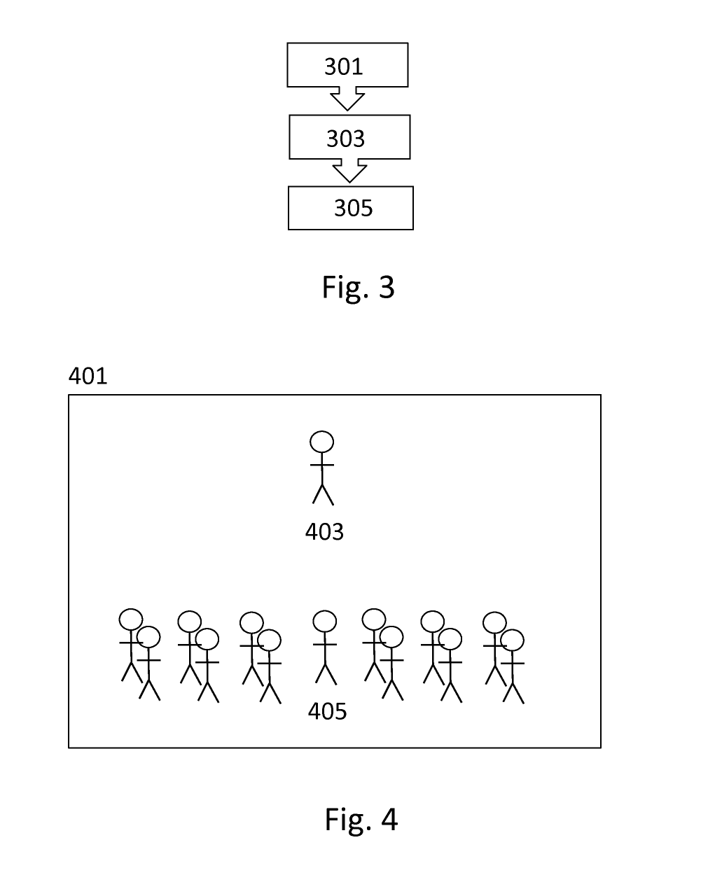

Referring to FIG. 3, shown is a simplified flow diagram of a method of matching a standard against an educational result A series of queries is defined for measuring student performance against a standard as taught. For example, for each sub-element of FIG. 2, a plurality of questions are defined to measure achievement of the educational expectation for the standard sub-element. Preferably, the questions are somewhat correlated to achieving the standard sub-element—passing—and are not reflective of many different sub-elements. Alternatively, the questions are, as a group, indicative of each of several sub-elements.

At 301, a lesson or plurality of lessons is taught to a class covering at least one sub-element. Upon completion of the lesson, a test is provided to each student including at least some of the questions relating to the at least one sub-element at 303. From the result, an evaluation of the performance of each student is determinable at 305. By grouping the students into a same class, an evaluation of the teacher is also possible based on overall class performance. Further, in larger schools or with results of many classes an evaluation of the administration of the school is supported.

In counter-distinction to prior testing methods, however, the method. of FIG. 3 then goes on to remediate the identified issues. As shown in FIG. 4, the teacher 403 in classroom 401 needs to improve his teaching style for teaching multiplication of fractions and student 405 needs to relearn adding fractions. Student 405 is not given a lower grade due to their test results, but is instead given assistance in the areas that were not learned sufficiently. The teacher 403 in classroom 401 is not punished or paid based on their performance; instead, the students learn the material properly and either the teacher 403 is provided remediation to improve teaching, the teacher 403 does not teach that specific sub-element to subsequent classes, or alternative support is provided to improve the teaching results.

Advantageously, the system focuses on remediation and ensuring educational completeness instead of focusing on grades and ranking. That is not to say that grades and ranking are not also possible, but the focus of the methodology is to improve the educational result of the system and of each individual principal, teacher, and student alike.

The questions associated with each sub-element often include many more questions than are necessary to test the sub-element. As long as a subset of the questions are sufficient to test the sub-element, then relying on the subset is sufficient for evaluation. Further, different students optionally receive different subsets during evaluation. Of course, careful definition of questions is important to ensure statistical correlation between results based on different questions. That said, inclusion of multiple different questions allows for evaluation and re-evaluation and also limits effects of information sharing or teacher “guidance.”

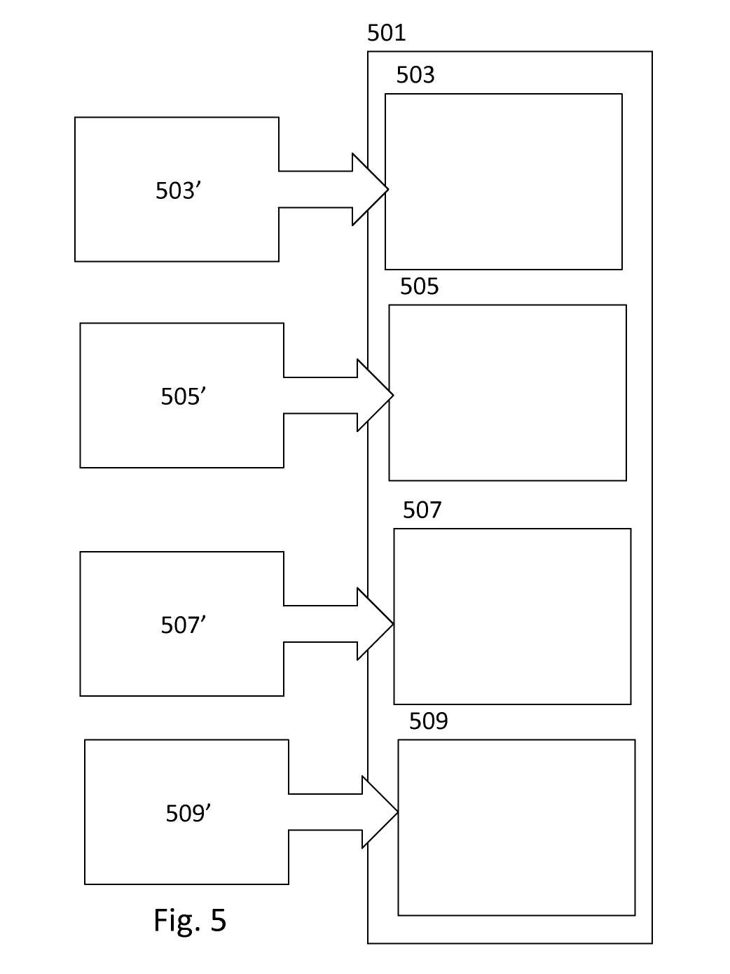

Referring to FIG. 5, shown is a simplified block diagram of a standard element 501 and sub-elements 503, 505 and 507 and questions 503′, 505′ and 507′ for the sub-elements. When each question is carefully chosen to be independent of other sub-elements, it is possible to test each sub-element independently and thus to remediate any student from any system as they enter a new system so long as the sub-elements are mapped one to another between different standards Alternatively, when the questions are not independent, then a group of sub-elements is evaluated in concert. Results of the evaluations are used to isolate a recommended remediation requirement; sometimes, a minimum remediation option is impossible to determine.

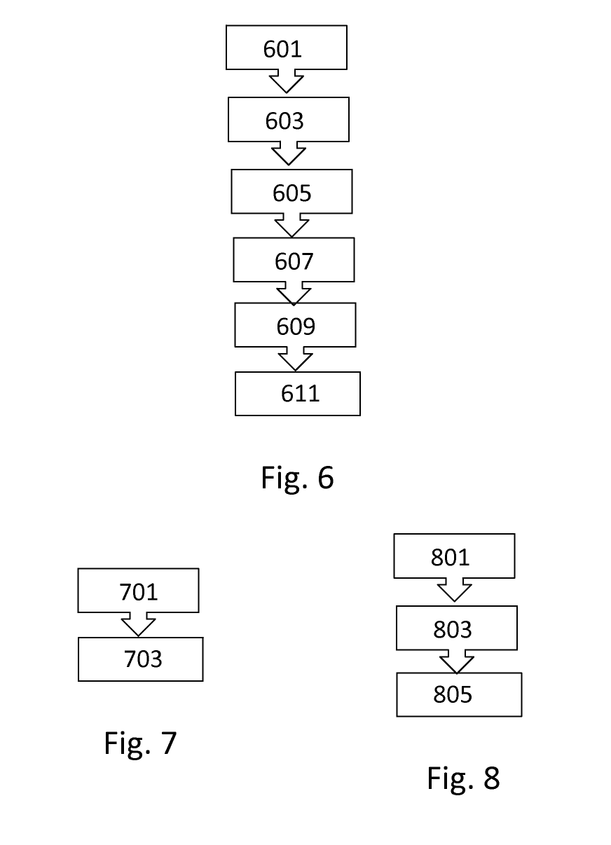

Referring to FIG. 6, shown is a simplified block diagram of a method of using test results to select a teacher. At 601, evaluation results for last year's grade 3 class are provided as comparative data, Evaluation of last year's students is performed to form a mapping of student performance last year to student performance this year at 603. Within the mapping, groups of students with correlated results are identified at 605 and their progress is evaluated based on their group and the teachers they have had at 607.

A group of grade 3 students is evaluated and based on their results is correlated with the grade 3 students from last year. These students fall into some of the identified groups from last year's grade 3 class. For each group, an outcome of assigning them to each available grade 4 teacher is determined based on this year's grade 4 class evaluation and then, based on this known data, grade 3 students are assigned to grade 4 classes and teachers at 609.

At 611, the results from previous evaluation for each student are used to correlate students and teachers and results. If students from past years with specific prior remediation requirements did better with a particular teacher in the subsequent teaching year, it is advantageous to place other students with similar presently indicated remediation requirements into that teacher's class. Alternatively, the student is directed towards educational tools, a particular yet non-limiting example is an online school.

FIG. 6 highlights three possible outcomes. First teachers are all excellent and distribution of students is based on need and not teacher quality. Second some teachers are better than others and either the effect on the outcome is nominal—the most independent students go to the worst teachers and thus see little change in their results, the teachers are advised to remediate their teaching and given specific areas to address, or third the teachers are provided additional support to balance the results. Thus, a method is provided to limit damage that is a result of poor teacher selection for a particular student.

Of course, stability of school staff enhances the statistical validity of the process allowing students to be directed to teachers that can best teach them. Further, teaching is improved through remediation. Also, student needs are best met. For example, students with similar “learning styles” likely take to similar teachers because of their teaching styles. Correlations that are found using the system of FIG. 6 indicate solutions based on available options as opposed to trying to remediate a problem using outside techniques. Matching of teachers to students is important and advantageously it is done in the present embodiment without evaluating teaching type or learning type of those involved based on psychological assessments.

Of course, learning and teaching styles are determinable from the groupings that are formed. Labeling of those styles is difficult without first having a baseline, for example a psychological assessment of a group of students. Though it may not be completely evident, students are assignable to teachers for a complete class year, a portion of a class year, a chapter, a standard element, a standard sub-element, a standard sub-sub element, etc. In a large school having many parallel classes each following a same curriculum, students in a same grade may be scheduled in different classrooms with different teachers and different student mixes for different sub-elements to provide ideal learner-teacher fit. Further, in some cases predictive remediation is supported wherein for some sub-elements smaller group sizes or one on one teaching is provided before evaluation based on a group with which that a student is associated.

For different standards, different courses, and different grade levels, students are evaluated and grouped, and as such, a student is not guaranteed to be in an identical group for math and literature. Whereas learning styles typically are an attempt to group a student's learning across all areas, the present methodology is committed to a single model or paradigm allowing for a student who is a self-learner in math to be encouraged in that way even if they are a slow reader with limited vocabulary. This even applies within a same course. A student that is an excellent writer but a poor writer of poetry or is excellent at one math concept but not clear on another is identifiable and each sub-element is remediated differently.

Beneficially, courses that are cumulative in nature—knowing last year's material is essential to doing well this year—like math are remediatable to ensure completeness of prior teaching before moving onto subsequent material. This avoids an ever present issue where a single bad year in math results in many bad years in math because that material is not sufficiently learned to support subsequent curricula.

Referring to FIG. 7, shown is a simplified flow diagram of a method of evaluating a student upon system entry to determine remediation. In today's global economy, student mobility is very important. We leave the concerns about courses, curricula, etc. to parents and students. By evaluating a student upon entry into a system of education at 701, a remediation plan is produced to ensure the student's education is complete according to the standard at 703. Thus, joining grade 4 in the middle of the year does not result in missing material from the first half of the year. Instead, the student is evaluated as to each sub-element allowing for specific remediation of those sub-elements that have not been adequately learned to result in the student having all the learning required under the present school's standard.

Referring to FIG. 8, shown is a simplified flow diagram of a method of notifying a teacher of potential issues. At 801, a teacher is notified of a class' evaluation results to suggest a remediation approach. Such a remediation approach is complex because it is unlikely that a single approach will best meet every student's needs. An approach that is statistically most relevant is suggested at 803. Outliers are either handled separately by the administration, for example through tutoring, or they are remediated through less optimal approaches at 805 as their cost benefit is lower that then cost benefit of the most relevant approach.

For example, evaluation determines that 12 students do not understand sub-element 12.2, one student does not understand sub-element 12.1 and a fourteenth student does not understand sub-elements 12.3, 12.4, and 12.5. Clearly, by remediating the 12 students, there is the most overall benefit, but by remediating the fourteenth student the students are set to the most balanced level. Of course this fails to account for stylistic and compatibility issues. As such, the remediation suggestions might be far more complex to generate. A system that statistically indicates remediation based on anticipated results is advantageous. For example, if the same teacher re-teaching sub-element 12.2 in previous years has not improved the overall results, the system will not recommend remediating the 12 students as it is unlikely to produce relevant results. Alternatively, the system will recommend to the administration that they remediate the 12 students with another teacher.

Advantageously, remediation and teacher allocation are performable without blame or judgment. In the end, the overall quality of the education, of the teaching and learning, is what is important to the system and to the administration. Of course, a teacher that fails to achieve teaching results with a statistically valid sampling of students and student types and that appears never to remediate would need to be removed from their present teaching, which is ineffective. Either they are assigned to teach something else—for example the system suggests alternative teaching options based on the teacher resume, evaluation results, and so forth—or they are removed from teaching classes.

In an alternative embodiment, the above assessment and correlation methodology is used to determine student types and teacher types in order to assign teachers and students to known learning/teaching styles and thus to assist in manual assignment or intervention in educating and/or remediating the student/teacher.

Similarly, tutors, substitute teachers, administrators, and other educators are evaluable and a remediation plan is determinable based on the standard evaluation.

Numerous other embodiments may he envisaged without departing from the scope of the invention.

What is claimed is:

1. A method comprising:
providing a population of students past and present;
providing a plurality of teachers;
providing a curriculum having sub-elements therein;
providing a plurality of questions each relating to a specific sub-element within the curriculum;
providing a plurality of answers to each of the plurality of questions, the answers each relating to a student from the population of students and to a teacher of the plurality of teachers who taught the student material relating to the sub-element;
correlating the answers of current students within a grade level against the answers of former students at that grade level to form correlated student groups;
providing a first plurality of teachers for teaching material for teaching a same sub-element; and,
based on answers provided in subsequent years by students within a same correlated student group and the teachers associated with those answers, assigning students within the correlated student group to teachers from the first plurality of teachers for a subsequent lesson comprising material for teaching the same sub-element.

2. The method of claim 1 wherein the subsequent lesson is a remedial lesson.

3. The method of claim 1 wherein the subsequent lesson is a subsequent school year.

4. The method of claim 1 wherein the subsequent lesson is a next element within a. common curriculum.

5. The method of claim 1 comprising:
labeling correlated student groups based on learning style.

6. The method of claim 1 comprising:
assigning students to teachers from the first plurality of teachers in dependence upon the answers and in dependence upon a cost function, the cost function for achieving an educational goat

7. The method of claim 1 comprising:
assigning students to teachers from the first plurality of teachers in dependence upon the answers and in dependence upon a cost function, the cost function for balancing cost against achieving an educational goal.

8. A method comprising:
providing a population of students;
providing a plurality of questions each relating to a specific sub-element within a curriculum;
receiving an answer to each of the plurality of questions from each member of the population of students;
for each sub-element determining one of competence and lack of competence for each student within the population of students based on the answers provided; and
providing at an output port a visual indication of specific remediation based on the determination.

9. A method comprising:
providing a plurality of questions each relating to a specific sub-element within a curriculum;
providing a plurality of students having learned the specific sub-element from a same teacher;
receiving an answer to each of the plurality of questions, from each student within the plurality of students;
for each sub-element determining one of competence and lack of competence of the teacher based on the answers provided; and
suggesting specific remediation for the teacher based on the determination.

10. The method of claim 9 wherein the specific remediation comprises remediation for the teacher to improve teaching of the material.

11. The method of claim 9 wherein the specific remediation comprises remediation for the teacher to provide to the plurality of students to improve learning of the material.

12. The method of claim 9 wherein the specific remediation comprises a remediation plan indicating a most statistically relevant corrective action based on the determination.

13. The method of claim 9 wherein the specific remediation comprises a remediation plan indicating a most statistically relevant corrective action based on the determination, the statistically relevant corrective action addressing all of the indications of lack of competence.

14. The method of claim 9 wherein the specific remediation comprises a. remediation plan indicating a most statistically relevant corrective action based on the determination, the statistically relevant corrective action addressing other than all of the indications of lack of competence.

15. A method comprising:
providing a student;
providing a standard curriculum having sub-elements therein;
providing a plurality of questions each relating to a specific sub-element within the curriculum, the plurality of questions provided in electronic form and stored within a common data store;
providing to the student a portion less than the whole of the plurality of questions, the portion selected form the plurality of questions;
providing from the student a plurality of answers to the provided questions;
automatically correlating the plurality of answers against sub-elements of the standard curriculum to determine portions of the standard curriculum that are satisfactorily understood and portions that require remediation.

16. The method according to claim 15 wherein each question relates to one sub-element in isolation.

17. A system comprising
a processor and data store for
providing a population of students past and present;
providing a plurality of teachers;
providing a curriculum having sub-elements therein;
providing a plurality of questions each relating to a specific sub-element within the curriculum;
providing a plurality of answers to each of the plurality of questions, the answers each relating to a student from the population of students and to a. teacher of the plurality of teachers who taught the student material relating to the sub-element;
correlating the answers of current students within a grade level against the answers of former students at that grade level to form correlated student groups;
providing a first plurality of teachers for teaching material for teaching a same sub-element; and,
based on answers provided in subsequent years by students within a same correlated student group and the teachers associated with those answers, assigning students within the correlated student group to teachers from the first plurality of teachers for a subsequent lesson comprising material for teaching the same sub-element.
